(19) United States
(12) Patent Application Publication
(10) Pub. No.: US 2009/0087355 A1
(43) Pub. Date: Apr. 2, 2009

(54) Variable plate heat exchangers

(76) Inventor: Robert Ashe, Hampshire (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/920,191

(22) PCT Filed: May 15, 2006
(86) PCT No.: PCT/EP2006/004549

§ 371 Date: Sep. 15, 2008

(30) Foreign Application Priority Data
May 13, 2005 (GB) 0509746.4

(51) Int. Cl. B01J 19/00; F28F 7/00

(52) U.S. Cl. 422/193; 165/185

(57) ABSTRACT

A heat exchanger is provided which is capable of sophisticated operations such as undertaking chemical reactions, where particular velocity profiles are required or unusual heat transfer profiles are needed and comprises a unitary heat exchanger comprising a plurality of distinct heat transfer elements or zones containing heat transfer fluid through which a process material flows wherein heat transfer fluid is delivered and removed separately to each heat transfer element or zone.

### BACKGROUND

1. Field of the Disclosure

This present disclosure relates to plate heat exchangers where the process material flows over the plate surfaces.

The underlying purpose of this design is to build a heat exchanger which is capable of more sophisticated operations such as undertaking chemical reactions, where particular velocity profiles are required or unusual heat transfer profiles are needed. Some of the functional requirements of this heat exchanger are:
The option of a heat transfer surface which is made up of multiple heat transfer elements these can be set or controlled independently.
The option of multiple stages with variable plate spacing.
The option of fitting instruments and fittings at different points within the process conduit.
The option of injecting or removing the process material from any plate.
The option of opening up the process conduits for cleaning or modification.
A design of heat exchanger which embodies the functional capabilities described above but retains a high degree of standardisation and modular construction.

To achieve the capabilities described above, a different kind of plate heat exchanger is required and this is described in this document.

2. Discussion of the Background Art

In this document, the material which is required to be heated or cooled within the heat exchanger is referred to as the ‘process material’. The process material may be a liquid, an emulsion, a super critical fluid, a vapour, a gas, a paste, solid particulates or a combination of these.

The phrase ‘process conduit’ refers to the space (such as channel, pipe, gap between plates etc) through which the process material flows.

The phrase ‘process conduit area’ refers to the cross-sectional area of the aperture through which the process material flows at a given point.

In this document, the phrase ‘uniform flow’ is used to describe a velocity profile of the process material passing through the process conduit (in a laminar or turbulent fashion) which is substantially constant across the face of the process conduit. It also implies that there are no pockets or dead spaces within the process conduit.

The term ‘substantially’ is used because some variation in velocity will arise as a result of drag effects caused by the conduit walls or some other effect. Uniform flow is a desirable flow condition for many types of process for which the present disclosure is intended. Uniform flow is not observed with all applications of this disclosure however. For example, a vapour condenser may contain a combination of gas and condensed liquid. The gas and liquid will travel at different velocities. Also, this disclosure is suitable for systems which may use pulsed flow and in such cases; transient reverse flow and back mixing will be observed. In some cases, uniform flow conditions cannot be achieved due to the internal geometry of the process conduit. In some cases (such as many condensing duties) uniform flow conditions may not be necessary.

Where a fluid is used to deliver or remove heat from the heat transfer surface it is referred to in this document as ‘heat transfer fluid’. The heat transfer fluid may be a gas or a liquid. This disclosure is also applicable to systems where the heat is delivered or removed by other means such as electrical heating and cooling.

The phrase ‘heat transfer perimeter’ in this document refers to the length of wetted perimeter in contact with the process material which serves to transmit heat into or out of the process material. The length of the heat transfer perimeter multiplied by the length of the given section of process conduit (assuming it is of constant area) gives the heat transfer area for that section.

The phrase ‘variable volume’ in this document describes heat exchangers where the process conduit area is different at different points along the process conduit. A simple example of a ‘variable volume’ heat exchanger would be a circular pipe (with for example a cooling or heating jacket wrapped around the outside) which varies in diameter at different points along the pipe. The variation in diameter may be achieved by step changes (or by a gradual change) in the diameter. There are also other methods for varying the process conduit area such as using displacement inserts or by varying the spacing of two plates (between which flows the process material).

The phrase ‘variable heat flux’ in this document describes a heat exchanger where the heat transfer surface is broken up into multiple zones and the amount of heating or cooling applied to each zone can be independently set or controlled. It can be argued that heat flux variation is a characteristic of any heat exchanger given that the heat flux will vary as the temperature of the process material or heat transfer fluid changes.

The phrase ‘variable plate heat exchanger’ in this document refers to a novel design of heat exchanger that is provided by this disclosure and which is suitable for use as a conventional heat exchanger or it may be used as a ‘variable volume’ or ‘variable heat flux’ heat exchanger or a combination of these.

The phrase ‘plate spacing’ in the context of this document describes the separation distance between two heat exchanger plates and it applies to the gap between the two plates which carries process material. Thus in this context a large plate gap creates a correspondingly large process conduit area.

In this document, a plate heat exchanger is a heat exchanger which has a series of flat leaves which serve as the heat transfer surface and the space between the leaves serves as the process conduit.

In this document the phrase ‘plate stack’ refers to a group of heat exchanger plates which are grouped together as part of a single machine.

Although not used in this document the phrase ‘variable power’ may be used in association with ‘variable volume’ or ‘variable heat flux’ where such methods are employed to provide non uniform heating or cooling capabilities.

Heat exchangers are often treated as single stage systems for design purposes. As a result, a single design value may be used as the basis for sizing the heating or cooling capacity and/or the process conduit area. In practice however the heat load may be significantly different at different points within the heat exchanger. The specific volume (e.g. gas cooling) or mass flow (e.g. scrubbers) of the process material may also be different at different points. If account is not taken of these localised variations, the heat exchanger may be oversized (in terms of heat transfer capacity and process conduit area) in some areas and undersized in others.

To illustrate the problem of non uniform heat load within a heat exchanger, FIG. 1 shows a process material (1) flowing through a long pipe around which is a cooling jacket (2). A temperature probe (4) is located in the pipe to measure the temperature of the process material emerging from the cooling pipe. A signal from this temperature probe is taken to a controller (3) and this is used to regulate jacket cooling. This allows the operator to control the final product temperature. FIG. 1 assumes that the process material is being cooled from 20° C. on entry into the pipe down to 10° C. on exit from the pipe. In this case therefore the temperature of the process material within this system is always between 20° C. and 10° C.

Consider now FIG. 2 where the process material (1) is a reacting mixture of two chemicals (5 & 6) which is liberating heat. If the heat exchanger is designed as a single stage, the zone where the two chemicals meet will get very hot even though the final temperature is within specification. The heat generated in this ‘hot spot’ (7) is gradually removed as the process material passes down the heat exchanger.

Hot spots can be very undesirable as they can damage the product or promote unwanted reactions. Cold spots (in the case of endotherms) can also be equally unwelcome. If extra cooling is applied to eliminate the hotspot, the product downstream of the hot spot will also be subject to a higher level of cooling. This will result in a product temperature which is too low and this may inhibit desirable process changes in the zone downstream of the hot spot. Alternatively, the excessive cooling may damage the product or cause ice or wax to form. Control problems can also be encountered in heat exchangers where significant changes to the heat transfer conditions (such as changing condensing loads or where the process material viscosity is changing) are encountered. If the heat exchanger operates as a single heat transfer stage, the result can be a very aggressive temperature control dynamic which can cause freezing, boiling or some form of thermal damage (according to the nature of the process). Thus a heat exchanger which has the same process conduit geometry throughout and only controls the process temperature at one point (usually the discharge point) is not ideal for certain categories of process and especially those where changing exothermic or endothermic activity is observed or where the physical properties are changing within the heat exchanger. It is also not ideal for processes which require unusual temperature profiles as they pass through the system or where other intermediate heating or cooling effects (e.g. strong agitation) might exist.

The solution to the problem described above entails the use of a more complex cooling (or heating) device which is capable of applying different amounts of heating or cooling power (per unit volume of product) at different points within the process conduit. This idea is not new however. Columns for continuous polymerisation reactions for example may have multiple independently controlled heat exchangers at different stages within the column. Extruders used in the food and plastics industries may use multiple independently controlled heating or cooling elements. There are also examples where the multi stage principle has been achieved by using multiple heat exchangers in series. The preferred design of the present disclosure is to utilise a means of regulating the heating and cooling which is based on multiple zones within the heat exchanger. The specific heating and cooling characteristics can be altered by modifying the ratio of process conduit area to heat transfer perimeter (‘variable volume’) or by varying the heating or cooling flux at different points within the heat exchanger (‘variable heat flux’).

In some operations, the specific volume of process material can change (e.g. cooling and heating of gases) as it passes through the heat exchanger. In other cases, the mass of gas passing along the heat exchanger may change (condensation or scrubbing). If the heat exchanger has a small but uniform process conduit area along its length, the process material velocity will change as it passes through the heat exchanger. This can have disadvantages. High velocities in some zones may promote erosion and or corrosion. High velocities may also cause droplets to be carried out of the heat exchanger. High velocities also require higher pressure drops to transport the process material which can make the system more costly to build and operate. A solution to this is to have an oversized process conduit. This however results in some sections having very low process material velocities. In such cases, this may cause the process material to travel in a non uniform flow manner which may be undesirable. The efficiency of heat transfer is also generally lower where the process material is travelling at lower velocity. In addition to this, a heat exchanger with unnecessarily large process conduits will be bigger and more costly to build. There are also some cases where the process material has substantially constant specific volume but it is desirable to vary the process material velocity for other reasons such as to prevent fouling or thermal damage to the product in a section where the physical properties or mass flow have changed. As before, these problems can be variously solved using ‘variable volume’ and or ‘variable heat flux’.

### SUMMARY OF THE DISCLOSURE

The present disclosure provides a design of plate heat exchanger which gives the user complete freedom to select plate spacing (both uniform and non-uniform plate spacing). It also has separate heat transfer fluid supplies to each plate and where necessary, the process material can be piped into or out of any plate. It also has design features that permit the user to fit a variety of instruments or fittings to each plate. This gives it superior capabilities to traditional heat exchangers and makes it an ideal design for use as a “variable volume” and/or “variable heat flux heat exchanger”.

Plate heat exchangers are a well established concept and many patents have been filed on them by such companies as APV and Alfa Laval. However, for many reasons the traditional plate heat exchanger does not lend itself to the concepts of ‘variable volume’ or ‘variable heat flux’.

### BRIEF DESCRIPTION OF THE DRAWINGS

FIG. 1 is a schematic representation of a non uniform heat load within a heat exchanger;

FIG. 2 is a schematic representation of a hot spot within the heat exchanger of FIG. 1;

FIG. 3 is a schematic representation of a heat exchanger broken up into six elements;

FIG. 4 is another embodiment of a heat exchanger which uses a substantially constant flow of heat transfer fluid;

FIG. 5 is a heat exchanger with automated valves for tuning;

FIG. 6 is a schematic representation of a variable heat flux heat exchanger;

FIG. 7 is a schematic representation of a heat exchanger with fixed stage valves;

FIG. 8 is a schematic representation of a heat exchanger with automated stage valves and a multi port valve;

FIG. 9 is a schematic representation of the preferred plate spacing between cooling plates;

FIG. 10 is a schematic representation of a single plate of the variable plate design;

FIG. 11 is a schematic representation of a four stage heat exchanger;

FIG. 12 is a schematic representation of a wedge shaped design;

FIG. 13 is a schematic representation of a variable plate concept with a cylindrical design;

FIG. 14 is a schematic representation of a sealing arrangement with a spacer;

FIG. 15 is a larger plate separation arrangement;

FIG. 16 depicts a thermally conductive sheet sandwiched between a pair of process plates;

FIG. 17 depicts a reduced volume design wherein the heat transfer fluid pipe is sandwiched between a pair of process plates;

FIG. 18 depicts how a single plate can be broken up into multiple heat flux stages by segmenting the heat transfer surface into zones;

FIG. 19 depicts how instruments can be fitted into the inter plate slots;

FIG. 20 depicts how uniform addition can be made across any plate;

FIG. 21 illustrates a bypass arrangement; and

FIG. 22 depicts a three layer system with the process slot sealed with a gasket to create the heat transfer slot.

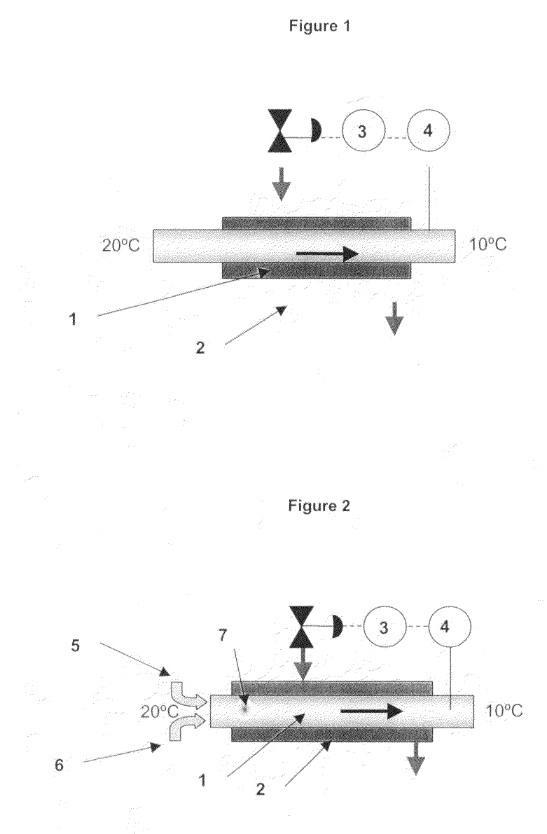

### DETAILED DESCRIPTION OF THE PREFERRED EMBODIMENT

### The Variable Plate Heat Exchanger

The considerations and solutions for this new variable plate design are discussed in the section below.

### (a) Variable Plate—Variable Volume

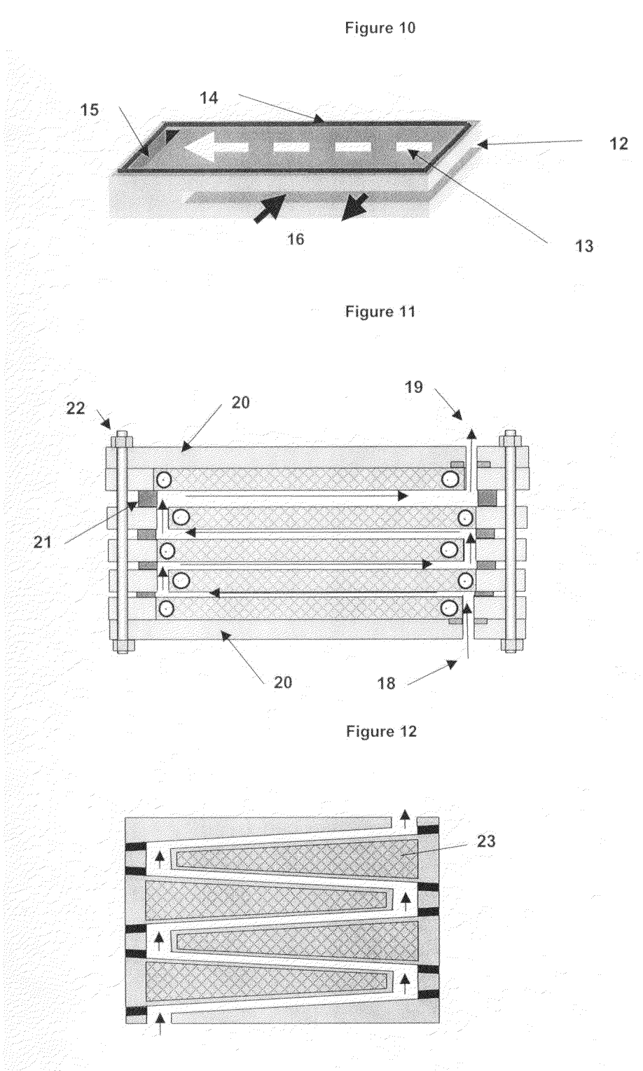

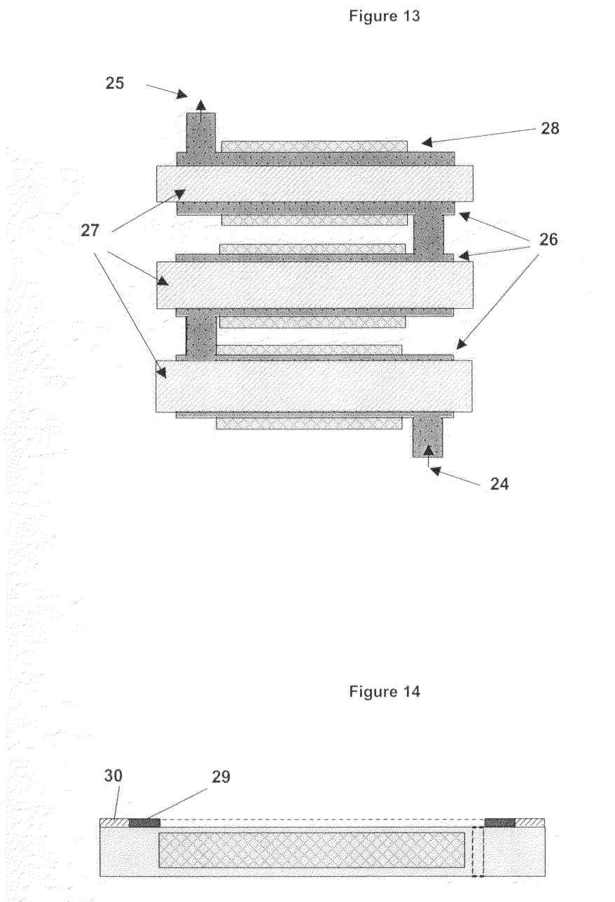

Traditional plate heat exchangers are made up with plate packs where the individual plates in a given plate pack have common plate spacings (although several different types of plate pack may be fitted within the same heat exchanger frame).
The preferred design of the present disclosure uses a plate pack which has two or more different plate spacings within it. Also the process conduit can pass directly though the heat transfer plate and, if necessary, this can be achieved without welds or seals on the inter plate conduit. Alternatively, the process conduit can be diverted into or out of the plate at any point in the plate stack. Also the heat transfer fluid conduit can be fed to each plate from the outside and does not need to pass through a space which is sealed from but surrounded by process material. FIG. 10 shows a single plate of the variable plate design. It can be made from a single block of material or in layers. A slot (heat transfer fluid slot) (12) is created through the thin plane of the plate from one end to near the other. This slot (12) is used as a heat transfer fluid chamber. It can be sealed up to create a flow passage for heat transfer fluid (16). A second hole is cut straight through the plate (the process material slot) (15) at one end to allow process material (13) to pass from one plate to the next. A seal (14) is fitted around the perimeter of the plate to create a sealed chamber when two plates are pressed together. Shims or spacers as per (21) of FIG. 11 can be used to control the separation distance between two plates. The process slots are placed on alternating sides to cause the process fluid flow over the full face of each plate. FIG. 11 illustrates how multiple plates can be stacked together in alternating directions to create a large multi stage variable plate heat exchanger.
FIG. 11 shows a four stage heat exchanger made up with five plates where the process material enters at the bottom (18) and exits at the top (19). Header plates (20) are fitted on either end of the heat exchanger. The plates can be assembled with spacers (21) and gaskets and compressed together using tie bolts (22) (or some other method). As the diagram shows, the plate spacings (in this example) get progressively larger as the process material proceeds through the heat exchanger (this would be suitable for an exothermic reaction where heat liberation is strongest in the early stages). In the case of a condenser, the plate spaces would tend to be large at the beginning and get progressively smaller through the heat exchanger.
FIG. 12 shows how a wedge shaped design can be used to create free draining characteristics across the whole system. For diagrammatic simplicity the variable plate spacing has not been shown.
In the design provided by this disclosure, the ratio of process conduit area to heat transfer perimeter can be altered by modifying either the process conduit area or the heat perimeter (at different points through the heat exchanger) however the preferred design of the present disclosure is that the heat transfer area per unit length of conduit path remains constant.

### (b) Variable Plate: ‘Variable Heat Flux’

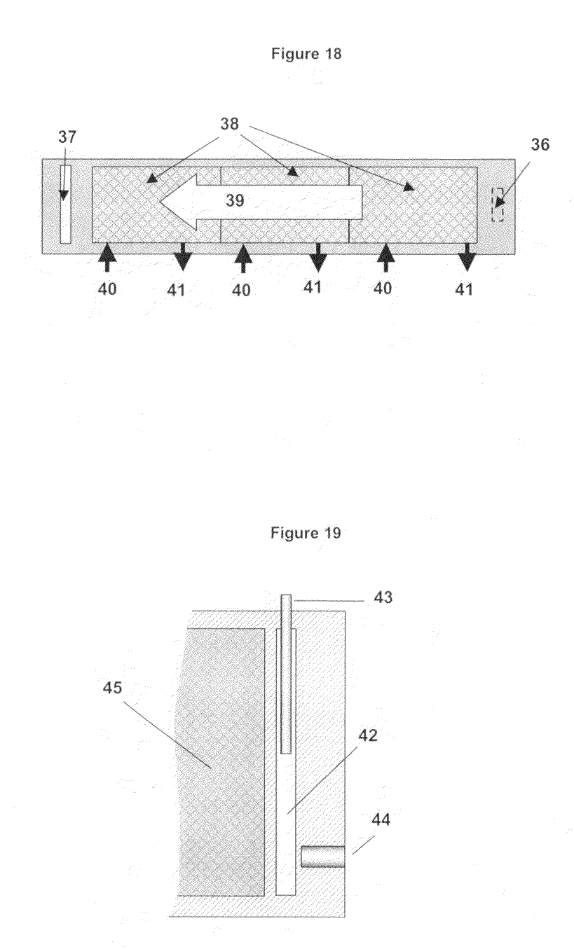

The design method described in section (a) above also lends itself to being used as a variable flux system. As it can be seen, the heat transfer fluid is delivered to each plate independently through a pipe in the side as shown by the flow arrows (16) in FIG. 10. The arrangement allows the designer to fit some form of controller or regulator on each heat transfer pipe. Alternatively, he could feed heat transfer fluid at a different temperature to each plate (although this might entail a more complex control system). The ability to vary the heat flux on each plate independently creates a ‘variable heat flux’ system.
Multiple heat flux stages can also be created on a single plate (or plates). FIG. 18 shows how a single plate can also be broken up into multiple heat flux stages by segmenting the heat transfer surface into zones (38). In this example three zones (38) have been created on a single plate. The process material enters through the slot from the previous plate (36), and flows along the plate surface (39) and exits in the slot (37) to the next plate. In each heat transfer zone the heat transfer fluid enters (40) and exits (41) the zone. If necessary, the inlet and outlet pipes (40 and 41) can be joined together to create a single long conduit. This arrangement would give the user the option to change from a single zone to multiple zones with minimal modifications.

### (c) Variable Plate—Plate Separation

Conventional plate heat exchangers have uniform plate gaps of usually between 1 and 5 mm. The preferred design of the present disclosure may use multiple plate gaps which can vary from less than 0.01 mm to more than 100 mm. A typical range however will be between 0.5 mm and 50 mm. If catalyst material is contained within the process conduit, the plate spacing may vary from 10 mm (or smaller) to 300 mm (or larger). The plate spacing of the different plates may vary by a factor of 2 or more. In some cases the different plate spacings may vary by a factor of 3 or more and some cases the plate spacings may vary by a factor of 5 or more.
The plate spacing is determined by the required velocity profile which may vary from less than 0.01 m·s⁻¹ to more than 20 m·s⁻¹. Typically however the velocity will be in the range of 0.05 m·s⁻¹ to 10 m·s⁻¹. Where the process material is a gas or vapour, the velocity may be 10 times larger than the above numbers. Baffles on the plates may be used to create a longer flow path across the plate and thereby increase the process material velocity to promote uniform flow, better mixing or better heat transfer conditions.

### (d) Variable Plate—Plate Sealing

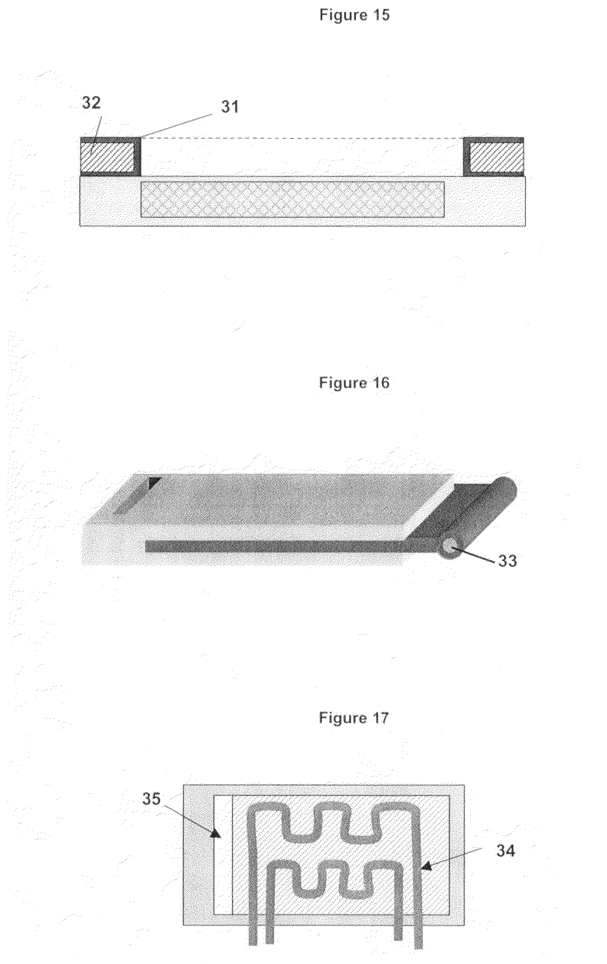

Traditional plate heat exchangers use profiled plates and gaskets clamped together. The same solution may also be used for the variable plate heat exchangers. The preferred design of the present disclosure however may use different solutions which may vary according to the required plate separation distance.
For very small spacing, the plates can be compressed together with a thin gasket but no spacer. In this case the plates can be designed to be touching or very close together and the flow channels are created by cutting a profile in the surface of one or both plates.
For slightly larger spacing, FIG. 14 shows a sealing arrangement with a spacer. Here, the plate separation is created by a hard spacer or shim (30) around the perimeter of the plate. Inside this sits a gasket or O ring (29) to form a seal.
FIG. 15 shows a larger plate separation arrangement. The spacer (32) shown has seals (31) on the top and bottom faces (in this diagram, the seal material has also been used to protect the wetted face of the spacer) of the spacer. Alternatively, O rings can be used.
The plate spacers can be designed to be tapered from one end of the plate to the other. This allows the ratio of the heat transfer perimeter to the process conduit area to be varied across the plate (in the direction of the process flow path).

### (e) Variable Plate: ‘Variable Volume’ and ‘Variable Heat Flux’ Stages

Traditional plate heat exchangers do not use the ‘variable volume’ or ‘variable heat flux’ concepts.
The preferred design of this disclosure will use two or more ratios of heat transfer perimeter to process conduit area on different plate stages. On some applications it will be preferable to use 3 or more, 4 or more, five or more or even 10 or more ratios of heat transfer perimeter to process conduit area on different plate stages.

Alternatively the preferred design of this disclosure will use two or more plates which have independent means of setting or controlling the plate temperature. On some applications three or more such plates (or groups of plates) may be used and in some cases this number may be 4 or more, five or more or even 10 or more.
Alternatively the preferred design of this disclosure will use two or more zones on each plate (or some plates) with heating (or cooling) profiles which can be independently set or controlled. On some applications it will be preferable to use 3 or more, 4 or more, five or more or even 10 or more zones on each plate (or some plates) with heating (or cooling) profiles which can be independently set or controlled.
Alternatively the preferred design of the present disclosure can employ a continuously changing ratio of heat transfer perimeter to process conduit area on a single plate stage. This can be created by using a wedge shaped process conduit. This can be achieved by using wedge shaped spacers for separating the plates or by cutting flow grooves on the plates of changing depth.
Alternatively the preferred design of this disclosure may use a combination of the stage concepts described above. A variable plate heat exchanger may have between two and more than two hundred stages.

### (f) Variable Plate: Simultaneous Heating and Cooling

Traditional plate heat exchangers employ heating or cooling. Where a combination of heating and cooling is required, a break in the plate pack is required. The design of the variable plate heat exchanger permits any combination of heat and cooling services to each plate without breaks or special modifications to the plate pack.

### (g) Variable Plate: Standardisation of Fabrication

Traditional plate heat exchangers have limited scope for non standard features such as ‘variable volume’ or ‘variable heat flux’ or more complex flow strategies. For example, the plate spacing of traditional plate heat exchanger is determined by the plate shape itself. The design of the present disclosure may also use the same fabrication technique. The preferred design however uses a separate component for determining the gap between the plates (but this may be welded to one or both plates during assembly). This allows the plates (which are the more expensive components) to be designed as standardised units and used for different plate spacings or different heat flux conditions. Also, by using wedge shaped spacers, process conduits with continuously varying process conduit areas are simple to fabricate.
Also, by providing a slot as shown by (12) of FIG. 10, for heat transfer, a variety of different heating and cooling (heating) arrangements can be used for a standard plate. For example an electrical heater could be used as could multiple small pipes within the space or an open (or baffled) conduit.
The variable plate design is also well suited to more complex flow strategies using standard components since the flow paths of the process fluid and the transfer fluid can be diverted into or out of the heat exchanger on every plate.

### (h) Variable Plate: Process Conduit Geometry

Side access to an individual plate of a traditional plate heat exchanger is only as wide as the plate spacing. In most cases, this is less than 5 mm and often less than 2 mm. Getting access to the plate internals is also a problem as there is a gasket in the way (other than all welded systems). This means that there is little scope for fitting instruments or fittings within the plate pack. There is also virtually no scope for fitting or removing instruments after the plate pack has been assembled.
Traditional plate heat exchangers cannot alter the length of the inter plate process conduit (shown as (12) in FIG. 10) without creating a substantial increase in volumetric capacity of the heat transfer fluid conduit. Also this increase in size of the heat transfer fluid conduit continues to get larger as the plate space process conduit length is made longer. The preferred design of the present disclosure allows for the length of the inter plate process conduit to be increased without increasing the capacity of the heat transfer fluid conduit (except where a point is reached that the two sides of the plate require separate supplies of heat transfer fluid owing to the thickness of the plate, but that this is a one off step increase in the capacity of the heat transfer fluid conduit).
Traditional plate heat exchangers use pipe conduits to deliver and remove process material from the plates. To alter the size of this pipe conduit requires a different gasket size, a different hole size in the plate and a different pipe size. The preferred design of the present disclosure allows the size of the process conduit between the plates to be modified by altering a single component. The preferred size can be achieved by machining a slot (as shown by (15) in FIG. 10) or drilling holes in the plate. If necessary, the plates can also be designed with large slots and have insert plates with different hole sizes or slots used to achieve the preferred profile. The design of the present disclosure will permit instruments to be fitted into the inter plate process conduit and that such instruments can be inside the body of the plate pack and fully surrounded by process fluid (where necessary).
If required, the size of the inter plate process conduit shown as item (15) in FIG. 10 has a process conduit area (whether it is a single slot or a series of holes) which is the largest that may be required for that particular heat exchanger range. This means that a single plate design can be used for any position on the plate stack. There are however instances where this principle would not be employed (for example where the inventory of the inter plate process material needs to be minimised).
In the preferred design of this disclosure, access to process material is not limited by the plate spacing. The inter plate process conduit (15) of FIG. 10 can be formed as an integral part of the heat transfer plate. By making the heat transfer plate wider (and longer) the inter plate process conduit can be made as large as is required. By creating a hole through the side or back of the plate, equipment like temperature probes, drains, sample points, instrument probes, emergency relief, and injection points can be fitted where ever needed. Also such instruments can be added or removed after the plate pack has been assembled.
Traditional plate heat exchangers have process conduits between plates that rely on gaskets or welds to isolate the process material from the heat transfer fluid. In the preferred design of this patent, gaskets, welds or joints do not have to be used to prevent heat transfer fluid and process material from cross contaminating each other. Also, the preferred design of the ‘variable plate’ heat exchanger does not require a double plate design.
Process material can also be diverted into or out of the plate at any point (as describe elsewhere and shown in FIG. 21).
Access to the process material can also be achieved from underneath the plate (from the heat transfer side) at any point. In this case, the penetration passes through part of the heat transfer slot (12) in FIG. 10. Alternatively, the process material can be accessed through holes in the spacer where it is thick enough. This is shown (21) in FIG. 11.

### (i) Variable Plate: Heat Transfer Fluid Conduit Geometry

The plates of traditional plate heat exchangers are not fed by heat transfer fluid with independent conduits to each plate and the heat transfer conduits pass through the main body of the plate pack. The preferred design of this disclosure is that the heat transfer fluid conduit enters each plate from the side to facilitate independent temperature control (or monitoring) of each plate. In FIG. 11, the + symbol indicates heat transfer fluid entering the system and − symbol indicates heat transfer fluid leaving the system (the direction of flow of the heat transfer fluid is optional). This allows heating and cooling fluids to be used simultaneously on different plates within the same plate stack and also different heat transfer fluids and different temperature control strategies on individual plates within the same stack.

### (i) Variable Plate: Plate Size

The plates of traditional heat exchangers are built in a range of different sizes. In the preferred design of the present disclosure, the plate area (on one side) can be the same size as any traditional plate heat exchanger may vary from less than 10 mm² to more than 10 m² but is normally in the range of 100 mm² to 1 m².

### (k) Variable Plate: Internal Profile

Traditional plate heat exchangers do not have clean crevice free and fully draining internal profiles. The preferred design of the present disclosure is for a heat exchanger which can have a clean internal profile and which can be fully draining and can be free of pockets or obstructions. Also the preferred design should be fully drainable either by fitting drains to each plate stage (or every other plate stage depending on orientation) or have a plate profile such that all the plates drain to a single point.
Where necessary, the inter plate process conduit can also be profiled such that the internal surface has no sharp corners which can trap dirt or product.

### (I) Variable Plate: Cleaning and Dismantling

Where traditional plate heat exchangers need to be opened up for inspection, cleaning or modification of the process conduit surface, seals have to be broken on at least 3 joints. With the preferred design of this disclosure, the process plate can be opened up for inspection, cleaning or modification of the process conduit surface and this can be achieved by breaking no more than two joints. Where the plate spacer is welded to one of the plates, only one joint has to be broken. It should be recognised that in some applications, more than two joints can be used for the preferred design of this disclosure.

### (m) Variable Plate: Flow Strategy

Traditional heat exchangers are limited to a relatively few options of cross flow, co-current flow or counter current flow. The preferred design of this disclosure is a system which can be totally flexible including co-current, counter current, cross flow, or a mixture of these (for either process material or heat transfer fluid). The reason for this flexibility is that heat transfer fluid and process material can be diverted into and out of the plate pack on every plate. This provides total flexibility for flow strategies. For example (which might be used for an exothermic process), the process material could flow through four plates in parallel followed by two plates in parallel followed by five single plates in series. The ability to use parallel and series flow together is valuable for scale up where narrow plate spaces on one stage could represent a capacity constraint. In some cases, plates can be skipped or the process fluid from one plate can be used as the heat transfer fluid for another plate (for heat recovery purposes).

### (n) Variable Plate: Flow Distribution

Traditional plate heat exchangers have a flow pattern whereby the process material enters and leaves each plate via conduits which do not cover the full width of the plates. Similar flow strategies are acceptable for the ‘variable volume’ and ‘variable heat flux’ heat exchangers. The preferred design of the present disclosure (for many applications) however is to maintain a uniform process material velocity and thickness across the plate. Failure to do so may lead to uneven process material temperatures across the heat exchanger and or back mixing (of product at different stages of reaction) and also stagnant pockets. It should be recognised many applications for which this equipment may be used (such as chemical reactions) may rely on lower flow rates than traditional heat transfer systems and such problems as those described above are generally more prevalent at low flow rates. It is desirable to distribute process material and heating (or cooling) uniformly across the flow path of the process fluid.
In the preferred design of the present disclosure, good flow distribution can be achieved by feeding the process material from the full width of the plate and discharging off the plate via the full width of the plate as shown by item 15 in FIG. 10. As an alternative to the inter plate slot (42) multiple inter plate holes can be drilled across the face of the plate. These small holes can be located within a slot or larger shallow holes to reduce the effect of non uniform velocity profiles near the inter plate holes.
Relatively long (in the direction of process flow) and narrow heat exchangers can be desirable for some applications as they offer more scope for cross mixing on the plate and have a reduced tendency for channelling by virtue of the plate width.
Alternatively, a greater number of relatively short plates can also be desirable, especially where narrow plate spacings are used. By using short plates, the impact of imperfections in the heat transfer surface (which will promote bias in the flow profile) is reduced.
Profiling of the heat transfer surface can be used to improve heat transfer area, heat transfer coefficient, and induce some cross mixing of process material across the surface of the heat exchanger.
A good flow profile can be promoted by having profiled ridges or baffles (across the full height of the plate gap) that follow the same direction of flow as the process material can be used to break up the flow path into a series of parallel channels.
Traditional plate heat exchangers do not use full width (or near full width) baffles on the plates. In the preferred design of the present disclosure, full width baffles and near full width baffles can be used. Full width baffles (flow control baffles) can be used to create a uniform flow (by having a series of small holes or slots across the full flow path). A different kind of baffle (mixing baffles) can be used to draw all the process material through a small hole on the plate for the purpose of mixing. If necessary, multiple flow control and mixing baffles can be used across the plate. Another kind of baffle (flow directing baffle) can be used to induce the process material to travel across the plate via a longer route (side to side or up and down). Baffle arrangements of this type can be used to maintain substantially uniform flow where the plate spacings are wide.

### (o) Variable Plate: Heat Transfer

Traditional plate heat exchangers pass heat transfer fluid directly through the full space between the heat exchanger plates. The design of the present disclosure allows for a similar solution and the slot (12) in FIG. 10 can be used as a plenum with or without internal baffles (to create preferred flow profiles of the heat transfer fluid).
An alternative technique is to use one or more small heat transfer conduits to deliver the heat transfer fluid. Reduced volume heat exchangers were described in PCT Publication WO2004/017007 A2. In the reduced volume design, an intermediate layer of conductive material is used to transmit heat between the heat transfer fluid conduits and the heat transfer surface. This is desirable for a number of reasons including more efficient and more uniform transmission of heat. A very small inventory of heat transfer fluid can be used and good control and efficient transmission of heat remains possible even at very low flow rates. This latter benefit is useful for heat balance calorimetry.
In the reduced volume design, heat from the heat transfer fluid is transmitted to the process heat transfer surface using conductive plates. PCT Publication WO2004/017007 A2 described how the conductive plates could be fitted to the heat transfer surface by clamping or spring loaded mechanisms and that conductive mats or grease could be used to exclude air between the copper plate and the heat transfer surface. The same concept can be used on the variable plate design. In the case of smaller plates, the heat transfer pipe (carrying the heat transfer fluid) (33) can be connected externally to a thermally conductive sheet which is sandwiched between the process plates as shown in FIG. 16. In the preferred design of the present disclosure, conductive plates within the heat transfer slot can be used. The alternative to a conductive plate is to use a thermally conductive filler to transmit heat between the heat transfer fluid conduit and the heat transfer surface. The following options can be used.
   The space between the plates can be filled with a good thermally conductive material like metal. Materials like lead, silver, tin, aluminium and copper are ideal for this as they have low melting points and good thermal conductivity. They can be melted into the space between the plates after the small pipe has been inserted (assuming that the process conduit material does not melt.
   The space between the plates can be filled with a conductive solid such as copper powder. Mixtures of different powder sizes can be used to achieve the best packing density. A mixture such as copper granules, copper powder and fine carbon black can also be used to achieve good packing densities. Once the system is filled, the powder can be compressed into place with inserts or other methods. Alternatively, a heat transfer element can be cast around a copper pipe (pipes) with thermosetting or thermo plastic. This can then be inserted between the leaves of the two plates in the location shown by (59) in FIG. 22.
   The space between the plates can be filled with solids as described previously and then filled with an inert liquid such as silicone oil to exclude the air. Such filling operations can be done under vacuum and/or at elevated temperatures to reduce the air. The system can then be sealed with a plate or a layer of filler material. Alternatively, the conductive solids can be set in a plastic, synthetic rubber or polymer material. Alternatively some form of grease can be used.
   A fluid can be used to transmit the heat from the heat transfer fluid pipe to the process heat transfer surface. This should be as thermally conductive as possible
FIG. 17 shows a ‘reduced volume’ design where the heat transfer fluid pipe (34) is sandwiched between two process plates. In this case two heat transfer fluid pipes are shown. It shows a plan view (showing a plate with the process slot (35) similar to the diagram featured in FIG. 10.
The heat transfer fluid can be delivered in a variety of co-current and counter current and cross flow configurations within each plate. This can be achieved with a flow plenum for the heat transfer fluid or a single or multiple small copper pipes. The use of co current and counter current flow strategies can be used to reduce non uniformity of heating or cooling.
Some plates may only have one side heated or cooled. For some applications it may be desirable to have a relatively thick plate (to create a large inter plate conduit for example). With very thick plates, it may be preferable to provide separate heating (or cooling) supplies to each side of the plate. In other cases a wedge shaped plate might be preferred.

### (p) Variable Plate: Special Fittings

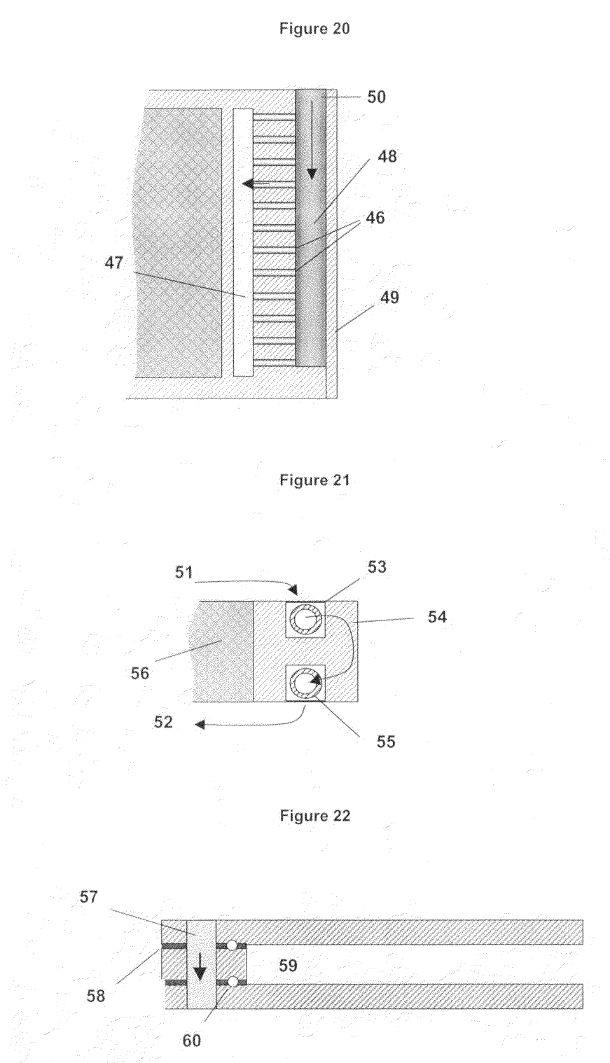

FIG. 19 shows how instruments can be fitted to the inter plate slots (42). A probe (43) could be fitted into the slot to measure such things as temperature or pH. A pocket could also be fabricated for a temperature probe (44) without cutting right through to the process conduit.
The process is unaffected by the plate thickness (other than a small increase in the inter stage process material hold up volume). Thus the heat transfer plates can be made thicker (where necessary) to mount larger probes within the inter plate slots.
The inter plate slots (42) or holes can also be fitted with drain points for such operations as draining condensate, cleaning or decontamination. Where the heat exchanger is used as a condenser, it could be oriented so that the flow of the process material passes up and down through the plates. The lower inter-plate slots could be fitted with drain points.
It may be desirable to add process materials to different plates in the heat exchanger. Uniform addition across the plate may also be desirable. FIG. 20 shows how addition can be made across any plate. In this example, multiple reactant injection nozzles (46) are drilled into the inter plate slot between the plates (47). The reactant is then supplied through a common reactant flow slot (48) (sealed with a slot cover (49) from a single reactant addition conduit (50). Where holes are used instead of a slot (for process material flow between plates), the holes for the injection points can be drilled to intercept at right angles or at a more oblique angle to create a venturi effect.
In some cases, it may be necessary to divert the process material out of the heat exchanger at the end of a plate. This might be required for example where some (or all) of the product needs to be passed through an instrument. Alternatively, the user may wish to pass process material through a series of plates in parallel (rather than series flow through each plate). Alternatively the user may wish to pass the process material through an inter stage booster pump to achieve a higher pressure drop through the heat exchanger without creating excessive pressures in the first few plates. FIG. 21 illustrates a bypass arrangement whereby product flowing (51) over the heat transfer zone (56) on one side of the plate reaches the process slot (53). It is then piped out of the system via a pipe on the side of the heat exchanger (54) and back in to a second slot on the underside of the plate (55). The product then flows out over the underside of the transfer zone on the other side of the plate (52). The process material pipes could also be taken out of the end of the heat exchanger rather than the side.

Special fittings (drains, sample points, addition points, temperature pockets etc) can be fitted at any point along the plate. This is because the sides of the plates are easily accessible via the heat transfer plenum or the plate spacer (where it is thick enough).

The variable plate design as shown in FIG. 10 lends itself to cleaning in place systems (CIP). Spray nozzles can be drilled into the plate around the process material slot (15) or mounted on a shoulder between the process slot and the gasket. Spray points could also be fitted within the spacer that separates the plates (item 21 in FIG. 11).

### (q) Variable Plate: Fabrication

Variable plate heat exchangers can be built in any normal material such as plastic, steel, alloy, glass, glass lined steel, plastic lined steel, titanium, tantalum, exotic alloys, stainless steel and a variety of other materials. The plates can also be lined or dipped or coated by some other means to create a protective layer. The thickness of the plates can be from less than 0.5 mm thick to more than 10 mm thick depending on the operating conditions such as pressure and temperature.
The plates for the variable plate heat exchanger can be cast, machined or fabricated in sections and welded together. They can also be fabricated from two or three layers of material and joined together by welding, soldering, gaskets, gluing or some other method. FIG. 22 shows a three layer system with the process slot (57) sealed with a gasket (58) to create the heat transfer slot (59). In a case where the plate is fabricated in layers, bleed holes (60) across the width of the plate can be provided to ensure that leaks by either the heat transfer fluid or the process fluid do not cross contaminate each other.
Two plates with their accompanying spacer may be welded together if this is preferred. Where access is required for cleaning, maintenance or modifications, the plates can be compressed together with gaskets. The gasket material may be metal, synthetic rubber, natural rubber, plastic, a composite of several materials (such as PTFE envelope gaskets). A double seal arrangement with a leak channel between the two seals can also be used if required.
An alternative fabrication method for the process conduit is to have two long strips of material (such as metal) folded into a series of passes and then sealed together with side panels to form a containment volume. Heat transfer surfaces can then be inserted into the folds from the outside.

### Variable Heat Flux Control

This section covers a description of variable heat flux control which is described in our Patent Application GB0509742.3. It can deliver valuable performance enhancements to the ‘variable plate heat exchanger’ design that is the subject of this patent.

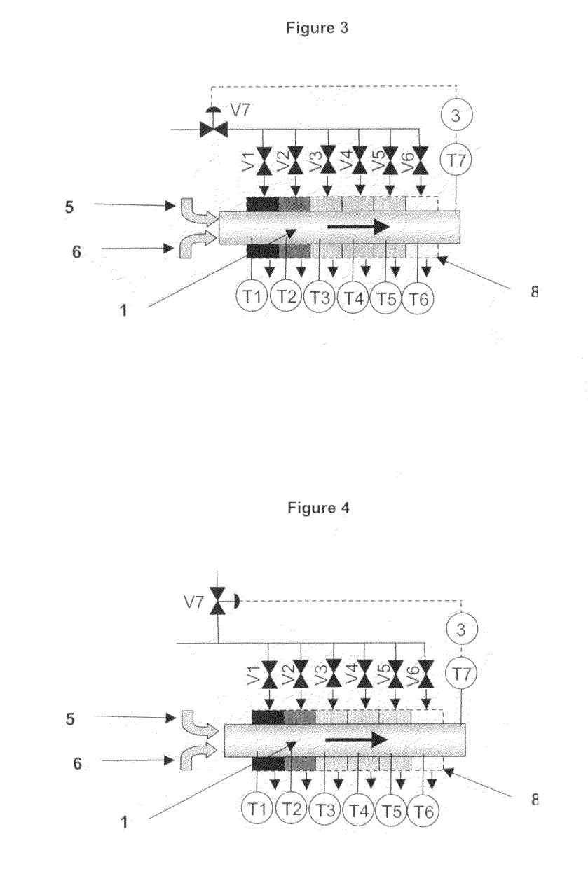

The principle of variable heat flux control is that the heat transfer surface is broken up into multiple sections and each section has an independent means of setting or controlling the temperature of the heat transfer surface. FIG. 3 shows a multi stage heat exchanger (8) around a pipe carrying a process material (1) where the cooling or heating power to each stage can be adjusted with a manual valve (V1 to V6).

The heat exchanger (8) in FIG. 3 is broken up into 6 elements. Each element has a manually operated valve (V1 to V6) and a temperature measuring instrument (T1 to T6). The stage valves (V1 to V6) can be adjusted so that the cooling power of each stage is different. As before we have assumed that two chemicals (5 & 6) are reacted together and this operation generates heat. The heat exchanger can be set up by turning on the two chemical reactant streams. The valve V1 is then adjusted until temperature T1 is acceptable. The next valve V2 is then adjusted in the same way. The process is repeated until all the heat transfer elements have been tuned. A heat exchanger set up in this way will deliver a much more uniform temperature profile through the heat exchanger (or a non uniform profile which suits the process needs). If the respective heats of reaction are known, the reactor could be set up with an inert fluid to get the heating or cooling conditions right.

The desired temperature profile across the heat exchanger may not be flat and in some cases, even a combination of heating and cooling elements may be used to achieve the ideal temperature profile.

Once a system has been tuned, a single automatic master valve (V7) can be used to switch on the cooling (or heating fluid) and regulate the final temperature (T7) using the temperature controller (3). It should be noted that a manual valve could also be used for V7. The control characteristics of this type of heat exchanger are different to a traditional system. If the master valve (V7) is adjusted (to accommodate a change in the operating conditions) the temperature profile across the entire heat exchanger will also be affected. Even though the temperature profile might cease to be optimally tuned under these conditions, it will still be better than a system without any inter stage regulation.

Where a heat exchanger is used for different process operations, the manual stage valves could be tuned as a set and replaced with different sets for other process operations.

An alternative design is shown in FIG. 4. This uses a substantially constant flow of heat transfer fluid (which may be recycled around the heat exchanger if necessary) but modifies the feed temperature of the heat transfer fluid by blending in a colder (or hotter) stream of heat transfer fluid using the master valve (V7).

The advantage with the design shown in FIG. 4 is that high flow rates of heat transfer fluid can be employed irrespective of the process heat load.

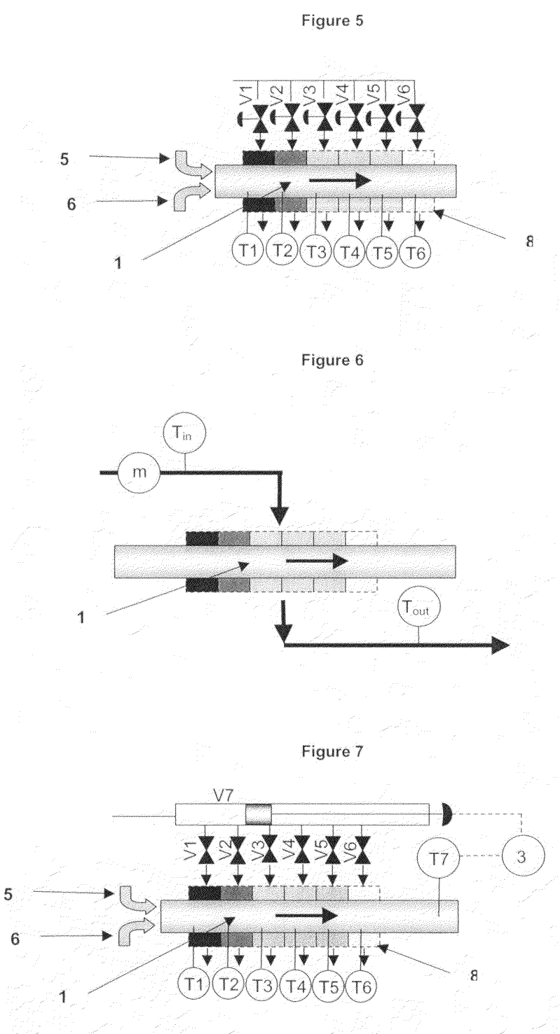

Automated valves can be used for tuning the heat exchanger (8) as shown in FIG. 5.

With the design shown in FIG. 5, the temperature elements (T1 to T6) are used to control the position of the respective valves (V1 to V6). Thus T1 is used to control V1 etc (for purposes of drawing clarity, the individual controllers have not been shown). The advantage with automated valves is that the valve positions can be set or modified automatically and information about the valve positions can be stored in the software. In this example, the master value (V7) referred to in FIGS. 3 and 4 has not been shown. For this design, V7 is not essential since V6 provides control of the final process temperature.

The ‘variable heat flux’ (or ‘variable volume’) heat exchanger can also be used as a calorimeter as shown in the simplified diagram FIG. 6 (where the valve and control details have not been show for diagrammatic simplicity).

The instruments shown in FIG. 6 include a mass flow meter for the heat transfer fluid (m), an inlet heat transfer fluid temperature (Tᵢₙ) and outlet heat transfer fluid temperature (Tₒᵤₜ). The specific heat of the heat transfer fluid in and out (Cpᵢₙ and Cpₒᵤₜ) can be determined from published literature, by experimentation or from a known mathematical relationship. The heat gained or lost by the heat transfer fluid (q) is calculated as follows:

q=(m·Cpᵢₙ·Tᵢₙ)−(m·Cpₒᵤₜ·Tₒᵤₜ) (W)

If the control strategy for the heat exchanger is based on inlet temperature of the heat transfer fluid (rather than mass flow of the heat transfer fluid) the system may use a recycle loop. In this case the heat balance (mass flow and temperature shift of the heat transfer fluid) can be determined by measuring the mass flow of fresh heat transfer fluid being injected into the recycle loop and measuring the temperature difference as it enters and leaves. As with any calorimetric method, the system will have to be zeroed for ambient losses, pump energy etc.

A heat balance on the process material can also be carried out by a similar method (by measuring the mass flow and temperature change as it passes through the heat exchanger).

The overall heat balance provides information about the efficiency of the reaction and allows the user to make intelligent decisions about such parameters as process feed rate, operating temperatures, recycle rates etc.

An alternative temperature control strategy is to use fixed stage valves positions (V1 to V6) and cascade them open with a multi port valve as shown in FIG. 7.

The design shown in FIG. 7 uses manual stage valves (V1 to V6) and these are set using the method described earlier. The multi port valve is used to switch on the heat exchanger and to control the temperature of the product leaving the heat exchanger. The multi-port valve allows the user to control the outlet temperature from the heat exchanger. In this design, it may be desirable to provide a number of similarly tuned stages at the back end (e.g. stages 3 to 6) to create some linearity of control for the final temperature.

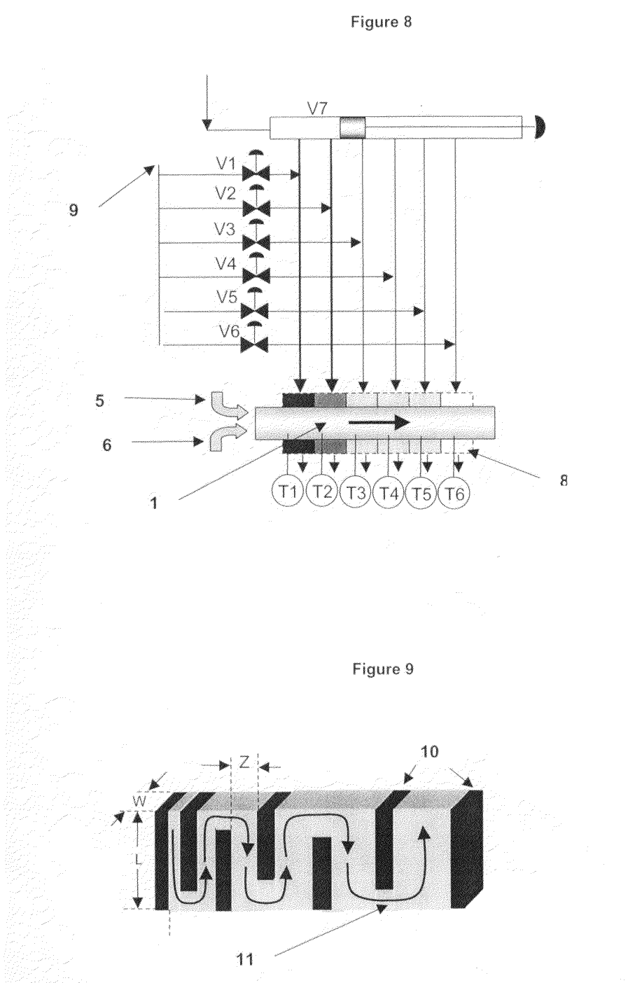

A heat exchanger with automated stage valves and a multi port valve is shown in FIG. 8 where the common pipe (9) is a source of hotter (or colder) heat transfer fluid.

The design shown in FIG. 8 allows the user to set the system up with different heat transfer areas. This is useful for modifying the sensitivity of the calorimetry or for changing the temperature control dynamics.

### Variable Volume Heat Exchanger Design

This section covers a description of the design principles for the ‘variable volume’ heat exchangers which is covered in our Patent Application GB0509742.3. It is one of the concepts that can be used as part of the ‘variable plate heat exchanger’ design.

The best way of illustrating the principle of ‘variable volume’ is to use a worked example as described in Table 1. The example is based on an exothermic reaction and the numbers used in this example have been created for illustration purposes only.

Assume that a process material is passing through a six stage plate heat exchanger. The reaction takes 11.4 seconds and liberates 6000 joules (per kg of product) of heat. To design the system, the process data needs to be examined in more detail. The heat load can be broken up into six time components that give comparable enthalpy releases as shown in the table below. The heat load could be broken up into more components, or could be divided into different ratios (for example the enthalpy values could be modified to compensate for variations in the heat transfer coefficient along the conduit).

TABLE 1
Rate of heat release during reaction

| | | | Heat released |
|---|---|---|---|
| Stage | Time start | Time end | J · kg⁻¹ |
| 1 | 0 | 0.2 | 1000 |
| 2 | 0.2 | 0.6 | 1000 |
| 3 | 0.6 | 1.4 | 1000 |
| 4 | 1.4 | 3 | 1000 |
| 5 | 3 | 6.2 | 1000 |
| 6 | 6.2 | 12.6 | 1000 |

| | | |
|---|---|---|
| Total | 11.4 seconds | 6000 |

The initial rate of reaction is very fast and then gets progressively slower. Therefore, and as shown in FIG. 9, the preferred plate spacing (Z) between the cooling plates (10) needs to become progressively larger as the process material (11) moves through the heat exchanger.

It is possible to calculate the cooling power (q) required per stage within the heat exchanger. For the example calculation, it is assumed that the heat exchanger shall be designed as a six stage system with each stage removing 1000 Joules (per kg) and that that product is fed to the reactor at a rate of 1 kg·s⁻¹.

Thus from Table 1, the heat load on the first stage is 1000 J and the residence time needs to be 0.2 seconds.

In the following equations note that the subscript numbers (_{1, 2, 3, 4, 5, 6}) have been used to denote that the conditions apply to the relevant stage number. Where no subscript is used, this implies that the same parameter applies to all stages.

The cooling power (q) on the first stage is:
q=Q/θ (W)
Where Q=total heat released in the stage (J)
θᵢ=residence time of first stage (s)
Therefore q₁=1000/0.2=5000 (W)

It is possible to calculate the heat transfer area (A) required per stage. For the example calculation, it is assumed that all stages have the same heat transfer area, the heat transfer coefficient is 1000 W·m⁻².K⁻¹ and that the process is operating at 30° C. and the cooling jacket is at 0° C.

The required heat transfer area (A) on each stage is:
A=q/(U·□T) (m²)
Where q=heat load on each stage (W)
U=overall heat transfer coefficient (W·m⁻²·K⁻¹)
□T=temperature difference on each stage (K)

Therefore for the first stage A=5000/(1000×30)=0.167 m²

Note: for this type of heat exchanger, all the plates have the same area and therefore the sizing of the first plate sets the plate dimensions for all the plates.

The length of each plate stage (L) is then calculated. For the example calculation, it is assumed that the plate is 3 times as long as it is wide

The length (L) of the plate on each stage is:
L=3W (m)
Where W=width of the plate (m)

The length of the plate on the first stage is also:
L=A/W (m)
Where A=heat transfer area per stage (m²)
W=width of the plate (m)

Note that the plate area for the first stage is half the heat transfer area. The reason for this is that there are two parallel plates on either side of the flow channel in the first stage.

Therefore substituting for W
L=[3×0.0835]^{0.5}=0.236^{0.5}=0.5 (m)

Next, the width of each stage (W) is calculated.

The width of the stage is:
W=L/3 (m)
Where L=length of each stage (m)
W=0.5/3=0.167 (m)

Then the linear velocity of process material on the first stage (V₁) is derived.

The linear velocity (V₁) on the first stage is:
V₁=L/θ₁ (m·s⁻¹)
Where L=the flow path length of the stage (m)
θᵢ=residence time of first stage (s)
Therefore V₁=0.5/0.2=2.5 (m·s⁻¹)

The next step is to find the volumetric flow rate of process material (G). It is assumed that the density (□) of the process material is 800 kg·m³.

The volumetric flow (G) rate is:
G=m/□(m³·s⁻¹)
Where m=mass flow rate of process material (kg·s⁻¹)
□=density of process material (kg·m³)
Therefore G=1/800=0.00125 (m³·s⁻¹)

The process conduit area of the first stage (a₁) can now be calculated:
a₁=G/V₁ (m²)
Where G=volumetric flow rate (m³·s⁻¹)
V₁=linear velocity of process material (m·s⁻¹)
a₁=0.00125/2.5=0.0005 (m²)

Now the plate separation gap on the first stage (Z₁) can be determined.

The plate separation gap (Z₁) is:
Z₁=a₁/W
Where a₁=process conduit area of the first stage (m²)
W=Width of plate (m)
Z₁=0.0005/0.167=0.003 (m)

Thus the plates for this design are 500 mm long and 167 mm wide. The plate separation on the first stage is 3 mm.

The plate separation gap on the second stage (Z₂) can then be derived in the same way.

Using the same method as for the first stage:
V₂=L/θ_{□}=0.5/0.4=1.25 (m·s⁻¹)
a₂=G/V₂=0.00125/1.25=0.001 (m²)
Z₂=a₂/W=0.001/0.167=0.006 (m)
Z₂=6 mm

The velocity and plate spacing for all the stages (calculations for 3, 4, 5 and 6 not shown) are shown in the Table 2 below.

TABLE 2
Fluid velocity and plate spacing for 6 stages.

| | Fluid velocity | Plate spacing |
|---|---|---|
| Stage | (m · s⁻¹) | (mm) |
| 1 | 2.50 | 3 |
| 2 | 1.25 | 6 |
| 3 | 0.63 | 12 |
| 4 | 0.31 | 24 |
| 5 | 0.16 | 48 |
| 6 | 0.08 | 96 |

As it can be seen from these results, the plate spacing gets very large in the latter stages (for this particular reaction). This can create fluid distribution problems. One option is to fit baffles in the latter stages (to increase the effective path length for the process fluid). Another option is to carry out the last few stages in a different type of heat transfer device. For example, the last few stages could be carried out in a large stirred batch tank or using a loop design. It could also be done semi batch mode with a cascade of medium sized stirred vessels. Alternative if uniform flow is required, the reaction could be carried out in a long pipe (with cooling) or in a shorter fatter tube with pulsating flow (with cooling).

A more rigorous analysis of each stage can be undertaken to evaluate the temperature profile across an individual plate. This may reveal that more than 6 stages are required to achieve a sufficiently uniform temperature profile. In some cases it may be necessary to vary the cooling power per stage in a non uniform way in order to create a specific temperature profile. In some cases this may require both heating and cooling on the same heat exchanger. When a suitable plate arrangement has been arrived at, the ‘variable heat flux’ technique can be applied to the plates (if necessary) to modify or fine tune the process temperature profile. This avoids the need for further mechanical modification of the plate gaps.

One could argue that judicious spacing of the plates can eliminate the need to vary the temperature of the heat transfer surfaces. Indeed the whole basis of variable volume design is that, if the right solution is employed a single temperature controller can deliver the preferred heating or cooling profile across the heat exchanger (even though the cooling or heating requirements are different in different parts of the heat exchanger. Whilst ‘variable volume’ is a good solution, the additional or alternative option of multiple independently controlled heat transfer zones is valuable enhancement for a variety of reasons:
There is a limit to how high the ratio of surface area to plate spacing can be altered. If the heat exchanger is designed as a series of small pipes, blockages will start to become a problem as the pipes get very small. If the heat exchanger is designed as a series of plates, blockages and channelling become a problem as the plates get closer together. If on the other hand, the ratio of heat transfer perimeter to process conduit area gets too small, flow distribution problems can be encountered or the equipment build cost could be greater.
In practice, the user may want to vary the heat exchanger operating conditions without having to rebuild the heat exchanger. This may be because the user wants to try out different temperature profiles. It could also be because the heat exchanger is required to handle different products or different product feed rates.
Design methods for sizing heat exchangers do not deliver perfect solutions for real life conditions. Calculations usually contain numerous approximations and assumptions. Process conditions can also vary in real life (e.g. delivery temperature or flow of process material). The ability to fine tune any design is an important function of control systems.

Therefore, the use of ‘variable heat flux’ in combination with ‘variable volume’ is a desirable design improvement (for some applications) to ‘variable volume’ on its own.

### Design of ‘Variable Volume’ and ‘Variable Heat Flux’ Heat Exchangers

This section outlines that, whilst both ‘variable volume’ and ‘variable heat flux’ principles can be applied to a number of heat exchanger designs, the ‘variable plate heat exchanger’ of the present disclosure is a particularly strong design solution for incorporating these principles.

In the example in the previous section, an exothermic reaction was divided up into 6 reaction stages and each stage had a similar enthalpy load over a given period. The problem could have alternatively been applied to an application where the specific volume of the process material was changing (such as a gas cooler) or where the mass flow was changing (such as a condenser) or where different heat transfer conditions were required for other reasons. In each case, the problem ultimately comes down to achieving a particular velocity profile. The velocity has implications for pressure drop, fluid mixing, flow profile, heat transfer, equipment size etc. The optimum design may include the use of ‘variable volume’ with continuously changing (e.g. wedge shaped) process conduit areas or multiple (but different) fixed process conduit area stages or a combination of both methods. Thus a condenser might have one or two wedge shaped process conduits followed by parallel ones (with the same or different process conduit areas). Once the desired velocity profile is known, the process conduit area can be determined for each stage (usually starting from the first stage) by determining the process material conditions at each stage (desired velocity, mass flow rate, specific volume) and heat transfer conditions at each stage. The heat transfer area per stage can be calculated once the number stages have been decided upon, or alternatively the number of stages could be calculated once the heat transfer area per stage has been decided upon.

The concept of variable volume allows a user to design smaller and more efficient heat exchangers. In the case of a plate heat exchanger, the size reduction can be in the form of a reduced number of plates or smaller plates or reduced spacing between the plates.

The concepts of ‘variable volume’ and ‘variable heat flux’ bestow a variety of benefits on heat exchangers for some types of process application. Whilst a variety of heat exchangers can be adapted to operate in either of these modes, there are three general classes of heat exchanger which are of particular interest as follows:

Heat Exchangers with Intrusive Heat Transfer Elements
Heat exchangers can be designed with a variety of intrusive heat transfer surfaces (such as internal coils, pipes or plates) within the process material. Intrusive heat transfer surfaces however have complex design relationships since any change to the heat transfer surface affects the process conduit area. They can also be difficult to clean and can be vulnerable to blockages. They can also create sub-optimal flow profiles such as uneven flow and or stagnant pockets. This can be undesirable for the process and make custom design or modifications difficult.

Heat Exchangers with Simple Geometric Profile
A preferred solution is a heat exchanger where the process conduit has simple internal geometry (apart from surface profiling for enhancing the heat transfer conditions and flow characteristics) and which only uses the process conduit containment surface as the heat transfer surface and does not have projections such as leaves coils or pipes within the process material. A simple manifestation of this concept is a round (or other simple geometric shape) pipe surrounded by a heating/cooling surface. For a given pipe diameter, the amount of heating or cooling that can be applied is dependant on fluid velocity and pipe diameter. By using a series of connected pipes of different diameters, the heat transfer perimeter to process conduit area can be adapted to meet the heat transfer needs at different stages of the process. To alter the heating or cooling capacity for a given pipe size, the process material velocity is changed. Unfortunately, the optimum range of flow capacities for a given pipe diameter is limited and the ratio of heat transfer perimeter to process conduit area falls as the pipe diameter increases. For this reason, the simple conduit approach has poor scale up or scale down characteristics.

Plate Design
A plate heat exchanger is an improvement on the simple pipe concept. It has a simple relationship between heat transfer perimeter and process conduit area (by varying the plate spacing). It has no obstructions and it is easy to build and clean. The plate solution is therefore a good solution for ‘variable volume’ heat exchangers.

### Process Benefits

The variable plate heat exchanger of the present disclosure has advantages over conventional plate heat exchangers in many respects. It can be built for general heating and cooling duties in the same way as a conventional heat exchanger (with uniform plate spacings). Because the user can define the plate spacings however, the heat exchanger can be set up with the ideal ratio of heat transfer capacity to mass flow capacity for a given application. Thus, by changing the plate spacers, the same heat exchanger plates could be adapted for use on high or low throughput of process material. A heat exchanger of this design can also have better heat transfer characteristics, drain points, sample points, inline line instruments on one or more plates, addition points, inter stage boost pump and more flexible options for flow strategies for the heat transfer fluid and the process fluid. This design also offers cleaner internal geometry and free draining characteristics (and cleaning in place where necessary)

The variable plate design is also ideal for exploiting the ‘variable volume’ and ‘variable heat flux’ principles. The benefits and uses of all of these are discussed below.

### (a) Uniform Temperature Control

Temperature control is essential for many process operations. Traditional temperature control techniques can provide very good temperature control of the final product but are not always good at preventing hot or cold spots. Transient deviations in temperature within a process can be undesirable. For example, temperature deviations can variously stop reactions from taking place or promote the wrong type of process change (such as the wrong reaction). In some cases temperature deviations can trigger dangerous runaway reactions. Temperature deviations can also cause undesirable changes to take place such as boiling, freezing or burning within a process. In the case of a polymerisation process, unwanted transient temperature deviations can affect product quality. Very good temperature control can enhance selectivity in some processes to give better yields and quality. By using the variable volume principle, the heat transfer capabilities of a heat exchanger can be profiled in such a way that a uniform temperature profile is maintained through the heat exchanger despite the uneven process heat load (on a per unit volume basis). In some cases, strong heating or cooling can be desirable at one point in the heat exchanger but cause damage in another (e.g. where viscosity is changing in heat sensitive products). The variable volume principle allows the user to moderate heating or cooling where required.
The additional feature of variable heat flux control allows the user to achieve a near ideal heating or cooling profile through the heat exchanger even where the variable volume profile is suboptimal. Some examples of applications (for exothermic and endothermic processes) are shown below.
   i) Organic chemical reactions
   ii) Inorganic chemical reactions
   iii) Polymerisation
   iv) Crystallisation
   v) Bio processes
      (b) Non uniform heat transfer conditions
For some processes which may or may not liberate/absorb heat it is necessary to take a process material above or below its preferred temperature range in order to effect a process change. For such operations, it is generally desirable to return the process temperature to an acceptable value as quickly as possible after the necessary change is complete. Pasteurisation of milk is an example of such a process. A preferred solution for this type of operation is a single piece of equipment which can deliver a specific temperature profile across the system. The ‘variable heat flux’ concept is ideal for this operation and allows complex (and modifiable) temperature profiles to be created within a single heat exchanger. Because the process conduit between the heating and cooling sections is so short, the delay in reducing the temperature is very short. This makes the variable volume and variable heat flux concepts ideal for some types of heat transfer operation in food, chemical, pharmaceutical and bio chemical processes.
Variable heat flux heat exchangers (with or without variable volume features) may also be used for more sophisticated control strategies. It might, for example, be desirable to allow a moderate temperature rise of the feed materials (by applying very weak cooling) followed by strong cooling at the end of reactor. In other cases it might be desirable to use heating and cooling simultaneously. For example, the reactants of a very strong exotherm could be mixed together in a very cold condition (to inhibit the reaction) and warmed by a small section of the heat transfer surface to initiate the reaction. By doing this, the reactants could be well mixed and in the ideal position on the heat transfer surface when the reaction starts. In some circumstances a given heat exchanger might employ a number of heating and cooling cycles.
The variable volume and variable heat flux concepts are good for process operations where a change in the physical properties of the process material could lead to problems. For example, in some food processing applications a change in the viscosity of the process material as it passes through the heat exchanger can affect the heat transfer properties and as a result lead to thermal damage or freezing or boiling in the product. By using variable volume and/or variable heat flux, strong heating or cooling can be applied at some stages and gentler heat transfer conditions can be applied elsewhere.

### (c) Variable Volume Processes

The ‘variable volume’ concept is ideal for handling process materials which vary in specific volume or mass flow rates. Examples include heating and cooling of gases and condensation or evaporation of liquids. ‘Variable volume’ for these applications provides better scope for optimising performance, size, cost, efficiency and pressure drop through a given heat exchanger. This offers the prospect of heat exchangers that give better performance, are cheaper to build and more energy efficient to operate. Variable heat flux can be an additional advantage for such applications given that the heat transfer coefficient and or heat load may vary significantly in such processes.
In the case of condensing duties, a combination of variable volume and variable heat flux can be used to good effect. This is particularly useful for systems designed to remove moisture or volatile compounds from gases. The formation of ice or wax can be monitored (using temperature, condensate flow, pressure drop, proximity switch to detect ice, electrical continuity, temperature changes in the heat transfer fluid etc) in vulnerable stages. When ice or wax starts to form, the heat flux within the given stage (or group of stages) can be modified to arrest the problem. The cooling power can then be increased on other stages as necessary to compensate for this. The heat exchanger can thus be set up with manual valves or continuously monitored for signs of icing and adjusted as necessary. Another control strategy (which does not have to use ‘variable heat flux’) is to monitor for ice formation and adjust the temperature of the whole system. Another control strategy (which does not have to use ‘variable heat flux’) is to monitor for ice formation and control the heat transfer area as shown in FIG. 7.

### (d) Improved Heating and Cooling Power

Some types of reaction liberate or absorb too much heat for conventional heat transfer equipment. An example of this is a chemical reaction where the transient temperature rise (or fall) of the reaction damages the product or affects the process in some way. In some cases, this effect can prevent the reaction being operated at all whilst in other cases the problem is managed by diluting the reaction mixture with a solvent.
Where a chemical reaction is liberating heat, the cooling that can be applied within a given time (and per unit volume of process material) can be increased by increasing velocity and reducing the thickness of the layer of process material as it passes over the heat transfer surface. As the velocity increases and the layer (between the two heat transfer surfaces) gets thinner however, so the pressure required to move the fluid increases. Pressure drop ultimately becomes the limiting factor to how thin the process conduit can be made for a given velocity. If the heat exchanger has a process conduit with a constant process conduit area, then a high pressure drop has to be applied across the entire unit rather than where the heat liberation (or absorption) is most vigorous. Thus on the basis of pressure drop alone, the variable volume design can always deliver better heat transfer performance where the liberation (or absorption) of heat from the process is non uniform. This means that heat exchangers built on the variable volume principle can control the temperature of stronger exotherms or more concentrated mixtures of reactants. This has numerous advantages such as faster reactions, better selectivity, reduced use of diluents etc.

### (e) Build Cost and Energy Saving

Many conventional heat exchangers employ design compromises for the benefit of standardisation. Plates for traditional plate heat exchangers for example are stamped out in shapes for specific plate spacing. In this respect, a standardised design may have to use a process conduit profile which is narrower than ideal. The penalty for this will be high operating costs (due to excessive drop). Alternatively, the selected process conduit profile may be wider than ideal. In this case, the build cost and size of the heat exchanger may be higher than ideal. Also sub optimal sizing of the process conduit can result in other problems such as fouling (for low velocities) and erosion (high velocities). Variable volume heat exchangers have a much higher degree of optimisation. The variable plate heat exchanger allows this optimisation to be achieved at a reasonable cost. The result is that such heat exchangers will perform better, and in many cases they will be cheaper to build and or operate.

### (f) Other Efficiencies

The heat transfer fluid in a variable plate heat exchanger is piped into each plate separately and the same can be achieved with the process conduits. Thus any number of flow strategies can be employed such as heat recovery systems. (E.g. where the process feed material is heated by the process discharge material).

### (g) Improved Process Control

The ability to monitor processes is an important factor in process control and optimisation. The variable plate design allows users to monitor and evaluate different temperature profiles across the heat exchanger. It also offers a simple means of taking samples for analysis at intermediate points. The temperature profile through the heat exchanger can be tuned to a variety of profiles. The heat liberated or absorbed by the process can be monitored. It also has good scale up characteristics (wider plate plates or multiple units). These features make it an ideal tool for research and development, scale up and full sized manufacturing plants.

### Applications

In any of the applications described below, the variable plate design is an ideal solution. In some cases the variable plate heat exchanger may be used with or without ‘variable volume’ or ‘variable heat flux’.
The technologies of variable heat flux, variable volume and the variable plate design are valuable for the process industries. They can be used in batch processes, semi continuous processes and continuous processes. Where it is used with batch or semi continuous processes, it is preferable that the variable plate, variable volume or variable heat flux heat exchanger is mounted within a recycle loop to achieve flow over the process surface. For these types of applications, benefits such as better selectivity of reactions, faster processes and reduced use of raw materials can be enjoyed. The heat exchanger can also be better sized for the process duty in terms of process conduit area (even where this is uniform across the plates).
Variable volume and variable plate heat exchangers are useful for applications where particular temperature profiles are required within the heat exchanger. This includes many chemical and pharmaceutical and bio pharmaceutical processes and also the many processes in the food industry.
Variable plate heat exchangers are ideal for reactions which use catalysts. For such applications, ‘variable heat flux’ is also a valuable addition. The catalyst material may be coated onto the heat transfer surface or it may be contained as some form of solid within the process conduit.
Variable volume, variable heat flux and variable plate heat exchangers are useful for applications where space or build cost (by virtue of size) is an important consideration. Examples include road vehicles, oil rigs, ships, aircraft, off shore installations, buildings, refrigeration systems, heating and ventilation systems etc. In the case of large systems, low cost heat exchanger elements could be created by using large sheet metal panels with small copper pipes (for heating or cooling) sandwiched between the plates (and with the possible use of a thermally conductive filler).
Variable volume and variable plate heat exchangers are useful for applications where pressure drop is an important consideration in running costs. This includes equipment for compressing, expanding, heating or cooling gas and vapour systems found in the bulk chemicals and petrochemicals industries. It also includes other large systems for gases and vapours such as heat and ventilation systems and refrigeration systems.
Variable plate heat exchangers have applications (with or without variable volume or variable heat flux) where clean internals and good self draining properties are desirable. Good applications for this include process condensers in pharmaceutical and fine chemical applications.
Variable plate heat exchangers are ideal for applications where disassembly for cleaning is desirable. This includes the food industry and pharmaceutical manufacturing but also other manufacturing processes where intermittent cleaning is desirable.
Variable volume, variable plate and variable heat flux heat exchangers are ideal for removing moisture and solvents from gas streams. In this respect they can be used for pollution abatement from chemical or pharmaceutical processes or for cooling combustion processes.
Variable plate heat exchangers can be used for heat exchange applications where a particular conduit size is required in relation to heat transfer area, or an option to modify the conduit size at minimal cost. In this respect, variable plate heat exchangers have many applications such as heating and cooling bulk process liquids or water.
Variable plate heat exchangers and variable volume exchangers can be used in the generation of steam, for heat transfer in nuclear reactors, in the water industry, in the chemical industry, in the petrochemical industry. They can be used for such applications as domestic heating and cooling systems, domestic water heaters and refrigerators.

1. A unitary heat exchanger comprising a plurality of distinct heat transfer elements or zones containing heat transfer fluid through which a process material flows wherein heat transfer fluid is delivered and removed separately to each heat transfer element or zone.

2. A heat exchanger according to claim 1 which is a plate heat exchanger.

3. A heat exchanger according to claim 2 comprising 2 or more plates.

4. A heat exchanger according to claim 2 provided with a hole within the body of the heat exchanger to enable the process material to pass directly from one plate to the next.

5. A heat exchanger according to claim 1 containing no seals or welds to prevent process material from entering the heat transfer fluid conduit.

6. A heat exchanger according to claim 3, wherein no seals are required to prevent the heat transfer fluid from entering the process fluid conduit.

7. A heat exchanger according to claim 1, wherein is provided with a slot or series of holes which span substantially the full width of the heat exchanger for the flow of process material into or out of each plate.

8. A heat exchanger according to claim 1, wherein the plates are held apart by at least one spacer.

9. A heat exchanger according to claim 8 in which the spacer is a separate item to the heat transfer plate.

10. A heat exchanger according to claim 8, wherein the spacer is profiled such that the plate spacing alters from end of the process conduit to the other.

11. A heat exchanger according to claim 1, wherein both heating and cooling are applied to different plates or different sections of plates.

12. A heat exchanger according to claim 1, wherein whereby the process material is piped into or out of the plate or any plate.

13. A heat exchanger according to any of the previous claims provided with attachments selected from drain points, addition points or relief pipes.

14. A heat exchanger according to claim 1, wherein one or more plates are provided with instruments.

15. A heat exchanger according to claim 14 wherein the instruments can be accessed or removed without dismantling the heat exchanger.

16. A heat exchanger according to claim 1, wherein the process fluid can pass through the heat exchanger in parallel flow or series flow or a combination thereof.

17. A heat exchanger according to claim 16 where the flow pattern can be altered without dismantling the plate pack.

18. A heat exchanger according to claim 16, wherein the process fluid from one plate or plate zone is used as the heat transfer fluid on another plate or plate zone.

19. A heat exchanger according to claim 18 in which the flow arrangements can be established without dismantling the plate pack.

20. A heat exchanger according to claim 1, wherein the plate assemblies are created in at least three layers with two of the layers serving as heat transfer layers and the third layer as a spacer between the two heat transfer layers.

21. The use of a heat exchanger according to claim 1 as a continuous reactor for chemical reactions.

22. The use according to claim 21 in which the reaction is a polymerisation reaction.

23. The use of a heat exchanger according to claim 1 as a heat exchanger for batch or continuous processes.

24. The use of a heat exchanger according to claim 1 as condenser.

25. The use according to claim 24 as an overhead condenser for batch processes.

26. The use of a heat exchanger according to claim 1 as a condenser for pollution abatement.

27. The use of a heat exchanger according to claim 1 in the manufacture of fine chemicals and pharmaceutical compounds.

28. A collection of components for the production of a heat exchanger according to claim 1 comprising a series of heat exchanger plates which when assembled provide a passage for the flow of process material and spacers which when assembled with the plates define the plate spacing for the passage for the flow of process fluid.
